(19) United States
(12) Patent Application Publication
(10) Pub. No.: US 2016/0217617 A1
(43) Pub. Date: Jul. 28, 2016

(54) AUGMENTED REALITY DEVICE INTERFACING

(71) Applicant: HEWLETT-PACKARD DEVELOPMENT COMPANY, L.P., Houston, TX (US)

(72) Inventor: Jeremy Edward Kark BARRIBEAU, Vancouver, WA (US)

(21) Appl. No.: 14/914,555

(22) PCT Filed: Aug. 30, 2013
(86) PCT No.: PCT/US2013/057470

§ 371 Date: Feb. 25, 2016

(51) Int. Cl. G06T 19/00; G06K 9/20; G06F 3/0486; H04N 1/00; H04N 5/232; G06F 3/0488

(52) U.S. Cl. CPC G06T 19/006; H04N 5/23229; G06F 3/0488; G06F 3/0486; H04N 1/00307; G06K 9/2054; G06T 2200/24; H04N 2201/0094

(57) ABSTRACT

Implementations of the present disclosure disclose an augmented reality interface. According to one implementation, an optical sensor is activated on a portable electronic device. A communicable object is connected with the portable electronic device upon being detected by the optical sensor. Moreover, a designated action is executed on the communicable object upon receiving input associated with the graphical representation of the communicable object on the user interface of the portable electronic device.

### BACKGROUND

The ability to provide efficient and intuitive interaction between computer systems and users thereof is essential for delivering an engaging and enjoyable user-experience. Graphical user-interfaces (GUI) are commonly used for facilitating interaction between an operating user and the computing system. Today, most computer systems employ icon-based GUIs that utilize icons and menus for assisting a user in navigating and launching content and applications on the computing system.

Meanwhile, the popularity of mobile computing devices coupled with the advancements in imaging technology—particularly given the inclusion of cameras within such devices—has given rise to a heightened interest in augmented reality (AR). In general, AR refers to overlaying graphical information onto a live video feed of a real-world environment so as to ‘augment’ the image which one would ordinarily see. Through the combination of augmented reality and graphical user interface, even more meaningful interactions are made available to the operating user.

### BRIEF DESCRIPTION OF THE DRAWINGS

The features and advantages of the present disclosure as well as additional features and advantages thereof will be more clearly understood hereinafter as a result of a detailed description of implementations when taken in conjunction with the following drawings in which:

FIG. 1 is a simplified block diagram of an augmented reality interfacing system according to an example implementation.

FIG. 2 is generalized schematic and conceptual diagram of an augmented reality interfacing system according to an example implementation.

FIGS. 3A-3B are illustrations of an example operating environment utilizing the augment reality interfacing system according to an example implementation.

FIG. 4 is a simplified flow chart of the processing steps for implementing augmented reality interfacing according to an example implementation.

FIG. 5 is another flow chart of the processing steps for implementing augmented reality interfacing according to an example implementation.

### DETAILED DESCRIPTION OF THE INVENTION

The following discussion is directed to various examples. Although one or more of these examples may be discussed in detail, the implementations disclosed should not be interpreted, or otherwise used, as limiting the scope of the disclosure, including the claims. In addition, one skilled in the art will understand that the following description has broad application, and the discussion of any implementations is meant only to be an example of one implementation, and not intended to intimate that the scope of the disclosure, including the claims, is limited to that implementation. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

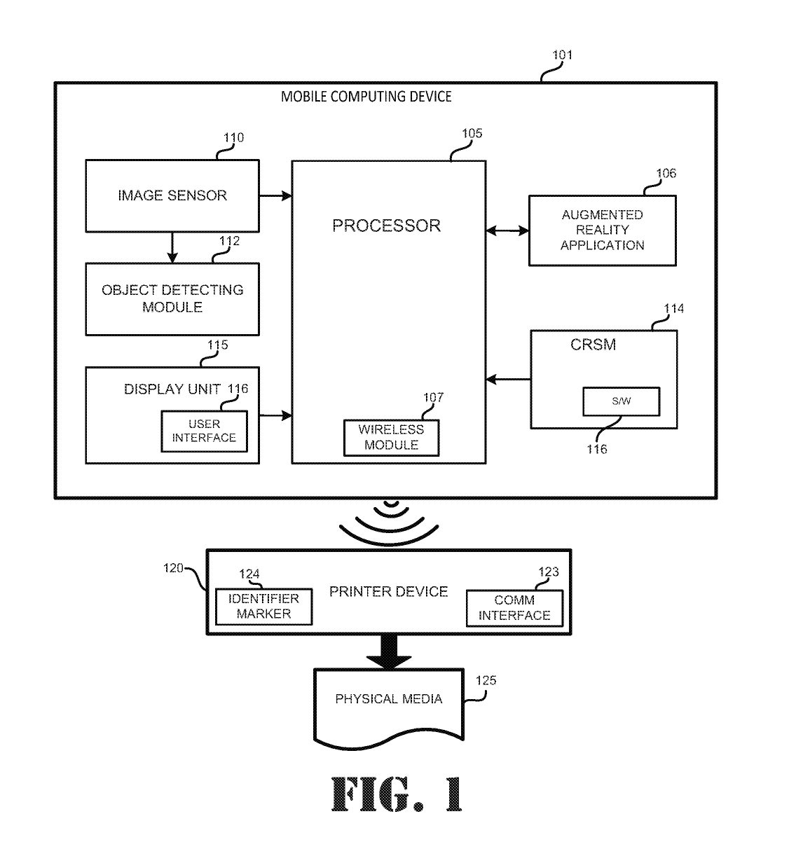

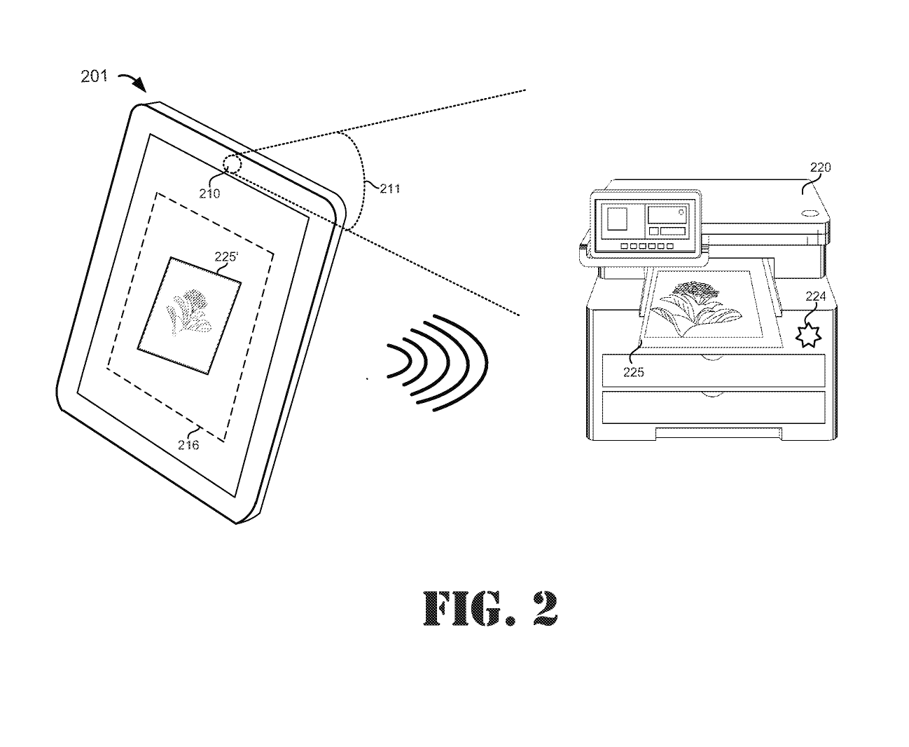

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Ordinarily, a user interface contains a multitude of information, which is presented via a traditional menu structure. Information is layered in a linear fashion according to a typical workflow. Whether designed for on-board printer control panels or third-party displays (e.g., smartphone/tablet), user interface software is designed to be compatible with a wide range of products and their varied capabilities. Consequently, a large amount of contextually irrelevant data and interaction options are presented. Additionally, the current method for remotely interacting with peripheral products is deficient in that the interaction is only metaphorically tied to the peripheral product by an abstract identifier such as a pictorial representation or product identifier for example.

Today, interaction with a peripheral device (e.g., printer) requires one to perform tasks either through the on-product display menu, driver software, or other application. For the latter two options, the peripheral device must be searched for, identified as a compatible device, added to the list of trusted devices, and then interacted with via options presented in a traditional menu system. This plethora of steps and interactions is time-consuming and often times frustrating (e.g., device not found) for the operating user. Augmented reality allows for a more efficient and tangible interaction between a remote device and a physical peripheral object.

Implementations of the present disclosure utilizes an augmented reality environment to automatically recognize a physical object desired for interaction with by a user, while also providing contextually relevant information and interaction options to the user. In one example, an optical sensor is activated on a mobile device and a communicable object is automatically connected with the mobile device upon being detected by the optical sensor. Moreover, a designated action, such as a print or scan operation, is executed on the peripheral device upon receiving input associated with a graphical representation of the peripheral device on the user interface of the mobile device. Accordingly, augmented reality offers a remarkable opportunity to simplify user interaction, and make virtual interaction with a physical object more tangible and logical.

Referring now in more detail to the drawings in which like numerals identify corresponding parts throughout the views, FIG. 1 is a simplified block diagram of an augmented reality interfacing system according to an example implementation. As shown in here, the system 100 includes a mobile computing device 101 for interfacing with a printer device 120 for example. Moreover, the mobile computing device 101 includes, for example, a processor 105, an augment reality application 106 installed thereon, an image sensor 110, an object detection module 112, a display unit 115, and a computer-readable storage medium (CRSM 114). The mobile computing device 102 may be, for example, a tablet personal computer, a smart phone, a notebook computer, a slate computing device, a portable reading device, a wireless email device, a mobile phone, or any other compact and portable computing device.

Processor 105 may be, at least one central processing unit (CPU), at least one semiconductor-based microprocessor, at least one graphics processing unit (GPU), other hardware devices suitable for retrieval and execution of instructions stored in machine-readable storage medium 114, or combinations thereof. For example, the processor 105 may include multiple cores on a chip, include multiple cores across multiple chips, multiple cores across multiple devices (e.g., if the computing device 101 includes multiple node devices), or combinations thereof. Processor 105 may fetch, decode, and execute instructions to implement the approaches described herein. As an alternative or in addition to retrieving and executing instructions, processor 105 may include at least one integrated circuit (IC), other control logic, other electronic circuits, or combinations thereof that include a number of electronic components for performing the functionality described herein.

The wireless module 107 can be used to transmit and receive data to and from other devices. For example, the wireless module 107 may be used to send document data to be printed via the printer device 120, or receive scanned document data from the printer device 120 via the communication interface 123. The wireless module 107 may be configured for short-wavelength radio transmission such as Bluetooth wireless communication. The wireless module 107 may include, for example, a transmitter that may convert electronic signals to radio frequency (RF) signals and/or a receiver that may convert RF signals to electronic signals. Alternatively, the wireless module 107 may include a transceiver to perform functions of both the transmitter and receiver. The wireless module 107 may further include or connect to an antenna assembly to transmit and receive the RF signals over the air. The wireless module 107 may communicate with a network, such as a wireless network, a cellular network, a local area network, a wide area network, a telephone network, an intranet/Internet, or a combination thereof.

Display unit 115 represents an electronic visual and touch-sensitive display configured to display images and includes a graphical touch user interface 116 for enabling touch-based input interaction between an operating user and the mobile computing device 101. According to one implementation, the user interface 116 may serve as the display of the system 100. The user interface 110 can include hardware components and software components. Additionally, the user interface 110 may refer to the graphical, textual and auditory information a computer program may present to the user, and the control sequences (e.g., touch input) the user may employ to control the program. In one example system, the user interface 110 may present various pages that represent applications available to the user. The user interface 110 may facilitate interactions between the user and computer systems by inviting and responding to user input and translating tasks and results to a language or image that the user can understand. In one implementation, the user interface 116 is configured to display interactive screens and video images for facilitating user interaction with the computing device 101 and an augmented reality environment.

Meanwhile, image sensor 110 represents an optical image capturing device such as a digital video camera. As used herein, the image sensor 110 is configured to capture images/video of a physical environment within a field of view for displaying to the operating user via the display 115. Furthermore, the object detection module 112 is configured to detect relevant peripheral objects or devices within the field of view of the image sensor 110 for establishing an automatic connection between the mobile computing device 101 and the relevant peripheral device (e.g., printer device 120).

Furthermore, an augmented reality (AR) application 106 can be installed on and executed by the computing device 101. As used herein, application 106 represents executable instructions or software that causes a computing device to perform useful tasks. For example, the AR application 106 may include instructions that upon being opened and launched by a user, causes the processor to activate the image sensor 110 and search (via the object detection module) for peripheral objects (e.g., printer 120) to automatically pair with the mobile computing device 101.

Machine-readable storage medium 114 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 114 may be encoded with a series of executable instructions for providing augmented reality for the computing device 101. Still further, storage medium 114 may include software 116 executable by processor 105 and, that when executed, causes the processor 105 to perform some or all of the functionality described herein. For example, the augmented reality application 106 may be implemented as executable software within the storage medium 114.

Printer device 120 represents a physical peripheral device and includes a communication interface 107 for establishing a wireless communication with the mobile computing device 101 as described above (e.g., over a local wireless network). In one example, the printing device 104 may be a commercial laser jet printer, consumer inkjet printer, multi-function printer (MFD), all-in-one (AIO) printer, or any print device capable of producing a representation of an electronic document on physical media (i.e., document 125) such as paper or transparency film. The printer device 120 further includes an identifier marker 124 affixed thereon that allows for object detection via a computer vision algorithm (associated with the object detection module 112) that determines the orientation and scale of the object (for which the marker is affixed) in relation to the user or camera 110 as will be described in further detail below.

FIG. 2 is generalized schematic and conceptual diagram of an augmented reality interfacing system according to an example implementation. As shown here, the augmented reality interfacing system includes a tablet device 201 within view of a printer device 220. The tablet device 201 includes a user interface for displaying images (e.g., electronic document 225′) to a user along with a camera device 210 formed at the rear surface thereof. As mentioned above, camera 210 may represent an integrated rear-facing camera configured to capture images of an environment within its field of view 211. More particularly, the camera device 210 and object detection module are configured to detect and wirelessly connect with a peripheral object such as printer device 220. In one implementation, object detection is achieved, for example, by using a printed fiducial marker 224, which is viewed by the camera 210 and then recognized by software (e.g., object detection module). Location, geometry and directional information associated with the identifier marker 224 may be used to calculate the perspective of the camera 210 (and therefore the user) in relation to surrounding objects and physical environment, including perspective, proximity and orientation. In one example, the fiducal marker 224 may be invisible to the naked eye and detectable via infrared wavelength light for example. However, the invention is not limited thereto, as image template matching, feature matching, or similar object detection and computer vision algorithms may be used for identifying peripheral devices available for pairing/wirelessly connecting with the mobile device.

As shown here, the tablet device 201 connects with the printer device so as cause printing of physical media 225 corresponding with the electronic document 225′ displayed on the user interface 216 of the tablet device 201. In another example, a user may send a digital video or photo document to a connected television monitor from the tablet device 201 for displaying on the larger display of the monitor. In yet another example, the user may start a file transfer with a connected personal computer by dragging documents on the user interface of the mobile device onto a graphical representation of the personal computer on the augmented reality application.

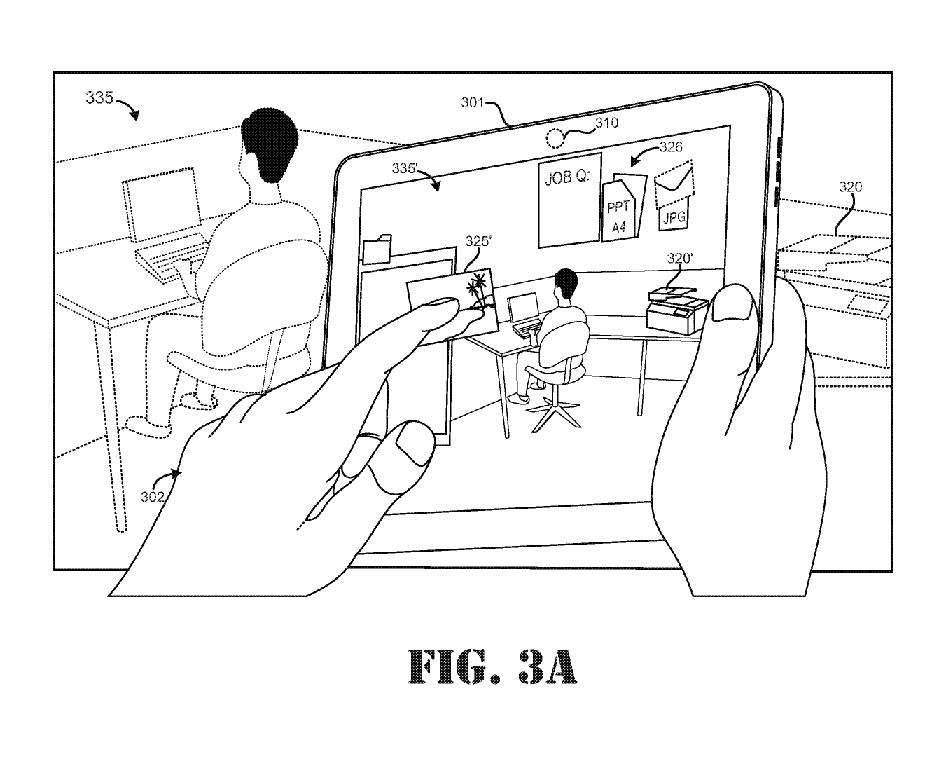

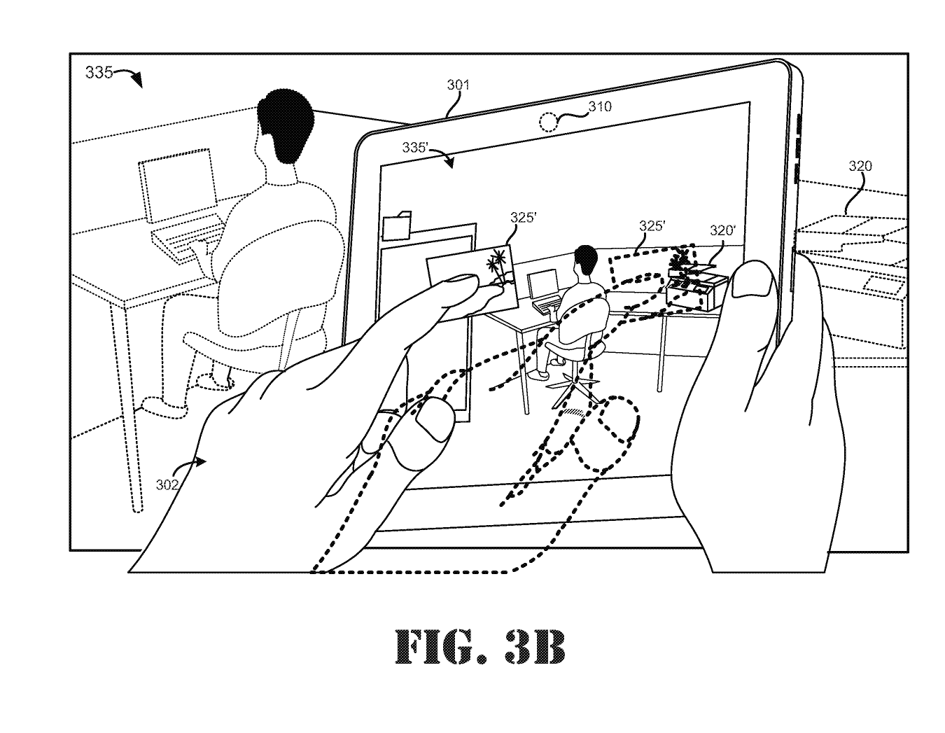

FIGS. 3A-3B are illustrations of an example operating environment utilizing the augment reality interfacing system according to an example implementation. As shown in the present example, the environment depicts an operating user 302 holding a mobile computing device such as a tablet computer 301. Additionally, the physical environment 335 includes an office area comprising of a user operating a personal computer along with a physical printer device 320 positioned nearby within the office area. An augmented image 335′ of the environment is replicated on the tablet device 301 via an embedded video camera device 310 and the user interface. More particularly, the operating user 302 views their surroundings or physical environment via the rear-facing camera 310 of the tablet device 301 while the AR application interprets and augments the environment image 335′ with visual data 326. The augmented visual data 326 may include static or moving two-dimensional or three-dimensional graphics to correspond to the perspective of the operating user.

Moreover, augmented reality may be used as an alternative to traditional user interface menus and is technically advantageous in that the augmented information presented may be more contextually relevant. As shown here, the augmented image 335′ includes relevant data 326 associated with the physical printer device 320. For example, the relevant data 326 may include the current print queue status, paper count and type, image quality and similar information relevant to the physical printer 320.

Referring now to FIG. 3B, implementations of the present disclosure allow for execution of a designated or predetermined action on a detected peripheral device based on user interaction with the augmented reality application and interface. For example, and as shown here, dragging a document icon 325′ from an on-screen file menu onto the graphical representation (e.g., printer device 320′ as viewed on the mobile display) may cause the tablet device 301 to send instructions (via the wireless connection) to the printer device 320 for printing the electronic document 325′ on physical media associated with the printer 320. Moreover, additional interaction options may be made apparent when contextually relevant. For instance, once a file icon (e.g., 325′) is dropped onto the printer image 320′ of the AR environment 335′, the user 302 may be presented with options relevant to that particular printer's capabilities, including but not limited to: duplexing, quality settings, color or black and white, alternative paper media options, and the like. In another example, the user may initiate a scan operation by tapping on the object representation 320′ so as to cause the mobile device 301 to send instructions for the printer 320 (e.g., all-in-one printer device) to scan physical media within its operating area such as a physical document on scanner bed or within an Automatic Document Feeder (ADF) for example.

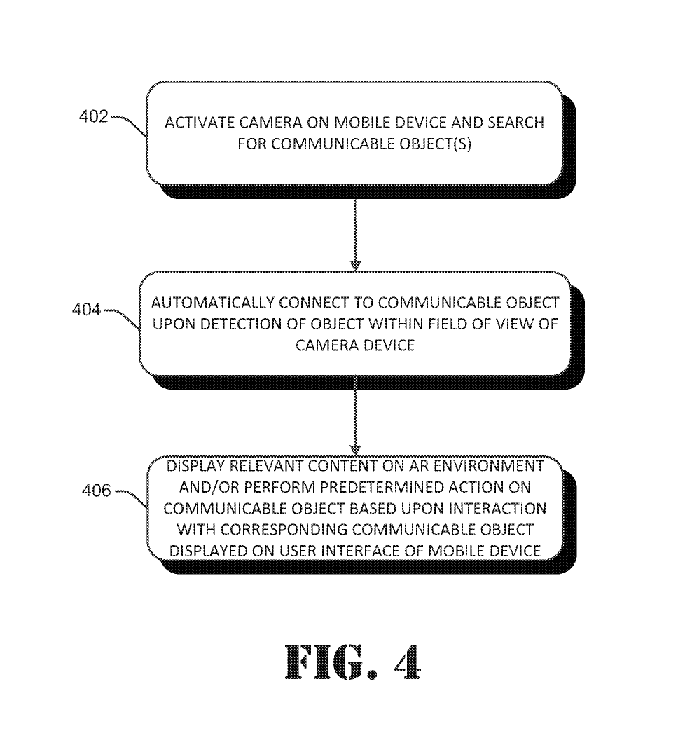

FIG. 4 is a simplified flow chart of the processing steps for implementing augmented reality interfacing according to an example implementation. In block 402, the user launches the augmented reality application from the mobile device which in turn activates the rear-facing camera of the mobile device. Once activated, the camera device searches—via the object detection module—for a communicable object. As used herein, a communicable object represents a peripheral or similar device capable of wirelessly connecting with the mobile device and detectable by programmed object detection algorithm. As discussed above, an object or device may be detected using an identifier or fiducial marker affixed thereon. Next, in block 404, the communicable object is automatically paired and connected with the mobile device upon detection of the communicable object within the field of view of the camera. The connection may be automated based up on a previous paring of devices. Alternatively, the user interface and AR application may prompt and guide the user to pair/connect to a detected device (e.g., via the device operating system settings). Thereafter, in block 406, based on user interaction (via the graphical user interface of the tablet device) with an image representation of the communicable object, a designated or predetermined action is performed on the physical object (e.g., print or scan document). Additionally, relevant contextual information (e.g., print queue) associated with the communicable object may be overlaid on the virtual environment so as to create an augmented environment based on user interaction with the graphical representation of the communicable object.

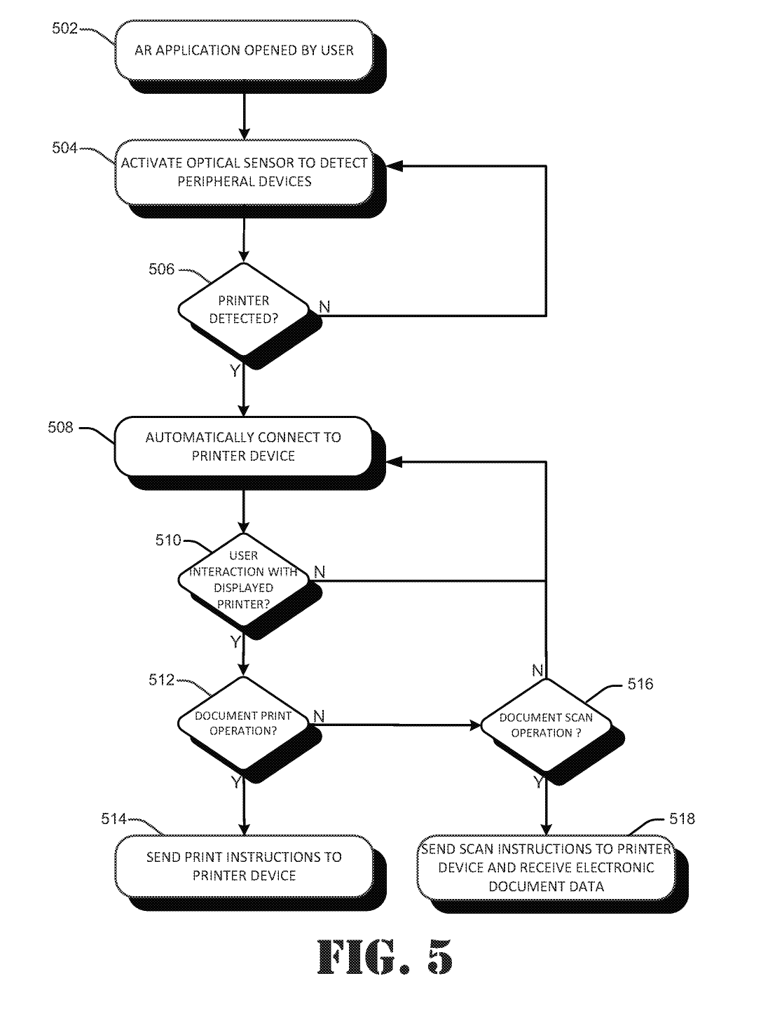

FIG. 5 is another flow chart of the processing steps for implementing augmented reality interfacing according to an example implementation. In block 502, the user interacts with the user interface of the mobile device to launch the augmented reality application. In response thereto, in block 504, an optical sensor (e.g., embedded camera or external web cam) is activated by the processing unit. Once a printer or other peripheral device is detected in block 506—through use of fiducial markers and an object detection algorithm as described above—in block 506, then the detected device is automatically paired and wirelessly connected with the mobile device in block 508. The coupling process may be accomplished through use of a previously paired connection (e.g., Bluetooth), exchange of IP addresses over a local area network, or the like. In the event a user interacts with the graphical representation of the peripheral device on the user interface in block 510, then a determination is made as to which event should be triggered. For example, a document print operation may be determined in block 512 if a user drags an electronic document over the graphical representation of the printer. Consequently, the processing unit may transmit instructions to the connected printer device to print the electronic document on a physical medium in block 514. Alternatively, a document scan operation may be determined block 516 in the event a user touches or taps the graphical representation of the printer device. In such a scenario, the processing unit may send instructions to the connected printer to execute a scan operation.

Implementations of the present disclosure provide augmented reality device interfacing. Moreover, many advantages are afforded by the system and method of device interfacing according to implementations of the present disclosure. For instance, the augmented reality interfacing method serves to simplify interaction through contextual menu options while also presenting relevant information and interaction options in a more user-friendly and tangible manner. The present implementations are able to leverage the larger displays and processor capabilities found in table computing device, thus reducing reliance upon on-product displays and lowering production costs of such devices. Furthermore, examples described herein encourage printing from portable devices (e.g., local file system and online/cloud storage) rather than immobile desktop computers, while also attracting and improving print relevance for a younger demographic of users.

Furthermore, while the disclosure has been described with respect to particular examples, one skilled in the art will recognize that numerous modifications are possible. For instance, although examples described herein depict a tablet device as the mobile computing device, the disclosure is not limited thereto. For example, the mobile computing device may be a smartphone, netbook, e-reader, cell phone, or any other portable electronic device having a display and user interface.

Not all components, features, structures, characteristics, etc. described and illustrated herein need be included in a particular example or implementation. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some examples have been described in reference to particular implementations, other implementations are possible according to some examples. Additionally, the arrangement o order of elements or other features illustrated in the drawings or described herein need not be arranged in the particular way illustrated and described. Many other arrangements are possible according to some examples.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. A method for providing augmented reality device interfacing comprising:
activating, via a processing unit, an optical sensor on a portable electronic device;
detecting, via the optical sensor, an communicable object;
providing for a connection between the portable electronic device and the communicable object upon detection, and
receiving, via a user interface associated with the portable electronic device, input associated with a graphical representation of the communicable object, wherein said input serves to execute a designated action on the communicable object.

2. The method of claim 1, further comprising:
displaying, via an augmented reality application installed on the processing unit, relevant information associated with the communicable object based on the user interaction with the graphical representation of the communicable device on the user interface.

3. The method of claim 1, wherein the communicable object is detected via fiducial markers affixed on the communicable object and recognizable by the portable electronic device when within the field of view of the camera.

4. The method of claim 1, wherein the communicable object is a printer device.

5. The method of claim 4, wherein the input comprises dragging an electronic document on the user interface onto the graphical representation of the printer device so as to cause the electronic document to print on physical media associated with the printer device.

6. The method of claim 4, wherein the input comprises touch selection of the graphical representation of the printer device on the user interface activates a scan operation by the printer device.

7. The method of claim 1, wherein the connection between the portable electronic device and the communicable device is established over a wireless network.

8. The method of claim 1, wherein the optical sensor is a rear-facing camera integrated within the portable electronic device.

9. An augmented reality device interfacing system comprising:
a tablet device having a rear-facing camera and an user interface for facilitating touch input from an operating user; and
an augmented reality application installed on the tablet device and configured to overlay graphics onto an image of a physical environment captured by the camera,
wherein a connection between the tablet device and the peripheral device is established upon the peripheral device being detected by the camera, and
wherein touch input associated with a graphical representation of the peripheral device on the user interface causes a designated action to execute on the peripheral device.

10. The system of claim 9, wherein the augmented reality application is configured to display relevant information associated with the peripheral device based on the user interaction with the graphical representation of the peripheral device on the user interface.

11. The system of claim 9, wherein the peripheral device is detected via fiducial markers affixed on peripheral device and recognizable by the tablet device when within a field of view of the camera.

12. The system of claim 9, wherein the peripheral device is a printer.

13. The system of claim 12, wherein when the touch input comprises dragging an electronic document on the user interface onto the graphical representation of the printer, a print operation is executed by the printer such that the electronic document is printed on physical media associated with the printer, and
wherein when the touch input comprises touch selection of the graphical representation of the printer device on the user interface, a scan operation is executed by the printer.

14. A non-transitory computer readable storage medium having stored executable instructions, that when executed by a processor, causes the processor to:
activate an integrated camera on a mobile computing device, wherein the mobile computing device includes an user interface for facilitating touch input from an operating user;
provide for connection between the mobile computing device and a printer device upon detection of a fiducial marker affixed onto the printer device, wherein the detection is made via the integrated camera of the mobile device;
provide for execution of a designated action on the printer device based upon touch input on the user interface associated with the graphical representation of the printer device, and
display relevant information associated with the printer device based on the user interaction with the graphical representation of the printer device on the user interface.

15. The computer readable storage medium of claim 14, wherein provide for execution of designated action on the printer includes executable instructions that further cause the processor to:
print an electronic document on physical media associated with the printer device when the touch input on the user interface comprises dragging the electronic document onto the graphical representation of the printer, and
scan a physical document on the printer device when the touch input on the user interface comprises touch selection of the graphical representation of the printer device.
